(19) United States
(12) Patent Application Publication
(10) Pub. No.: US 2025/0086938 A1
(43) Pub. Date: Mar. 13, 2025

(54) IMAGE CLASSIFICATION APPARATUS, IMAGE CLASSIFICATION METHOD, AND NON-TRANSITORY COMPUTER-READABLE MEDIUM HAVING IMAGE CLASSIFICATION PROGRAM

(71) Applicant: JVCKENWOOD Corporation, Yokohama-shi (JP)

(72) Inventor: Hideki TAKEHARA, Yokohama-shi (JP)

(21) Appl. No.: 18/826,235

(22) Filed: Sep. 6, 2024

(30) Foreign Application Priority Data
Sep. 11, 2023 (JP) 2023-146968

(51) Int. Cl. G06V 10/764; G06V 10/74; G06V 10/77; G06V 10/774; G06V 10/80; G06V 10/82

(52) U.S. Cl. CPC G06V 10/764; G06V 10/761; G06V 10/7715; G06V 10/774; G06V 10/806; G06V 10/82

(57) ABSTRACT

A deep-layer feature vector extraction unit extracts a low-resolution deep-layer feature vector of an input image. A shallow-layer feature vector extraction unit extracts a high-resolution shallow-layer feature vector of the input image. A concatenation unit concatenates the deep-layer feature vector and the shallow-layer feature vector and outputs a concatenated feature vector. A similarity calculation unit retains a weight matrix of respective classes and calculates similarities from the concatenated feature vector and the weight matrix of respective classes. The shallow-layer feature vector extraction unit shares at least one convolutional layer with the deep-layer feature vector extraction unit.

### CROSS REFERENCE TO RELATED APPLICATION

This application claims the benefit of priority from the prior Japanese Patent Application No. 2023-146968, filed on Sep. 11, 2023, the entire content of which is incorporated herein by reference.

### BACKGROUND

### 1. Technical Field

The present disclosure relates to image classification technology.

### 2. Description of the Related Art

In recent years, a deep neural network (DNN) that uses a convolutional neural network (CNN), etc. is used as a feature extractor to extract a feature amount of an image.

It is known that the feature representation capability of a feature extractor depends mainly on the amount of weight parameters included in the deep neural network and the amount of data for the training image.

Patent Literature 1 describes a technology for image classification using a feature extractor. Patent Literature 2 describes a technology for inputting images of a plurality of resolutions to a feature extractor.
[Patent Literature 1] JP2019-211913
[Patent Literature 2] JP2023-48794

In the related art, there is a problem in that the feature representation capability obtained from the feature extractor cannot be increased to a sufficiently high level.

### SUMMARY

An image classification apparatus according to an embodiment of the present disclosure includes: a deep-layer feature vector extraction unit that extracts a low-resolution deep-layer feature vector of an input image; a shallow-layer feature vector extraction unit that extracts a high-resolution shallow-layer feature vector of the input image; a concatenation unit that concatenates the deep-layer feature vector and the shallow-layer feature vector and outputs a concatenated feature vector; a similarity calculation unit that retains a weight matrix of respective classes and calculates similarities from the concatenated feature vector and the weight matrix of respective classes; and a classification determination unit that determines a classification of the input image based on the similarities.

Another embodiment of the present disclosure relates to an image classification method. The method includes: extracting a low-resolution deep-layer feature vector of an input image; extracting a high-resolution shallow-layer feature vector of the input image; concatenating the deep-layer feature vector and the shallow-layer feature vector and outputting a concatenated feature vector; retaining a weight matrix of respective classes and calculating similarities from the concatenated feature vector and the weight matrix of respective classes; and determining a classification of the input image based on the similarities.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

The disclosure will be described with reference to the following drawings.

FIG. 1 is a configuration diagram of an image classification apparatus according to the embodiment;

FIGS. 2A-2C are configuration diagrams of the feature extraction unit;

FIGS. 3A-3C show further exemplary configuration diagrams of the feature extraction unit;

FIG. 4 is a flowchart showing the learning process performed by the image classification apparatus;

FIG. 5 is a flowchart illustrating the classification process performed by the image classification apparatus;

FIG. 6 is a flowchart illustrating another example of the learning processing performed by the image classification apparatus; and

FIG. 7 is a flowchart illustrating still another example of the learning process performed by the image classification apparatus.

### DETAILED DESCRIPTION

The invention will now be described by reference to the preferred embodiments. This does not intend to limit the scope of the present invention, but to exemplify the invention.

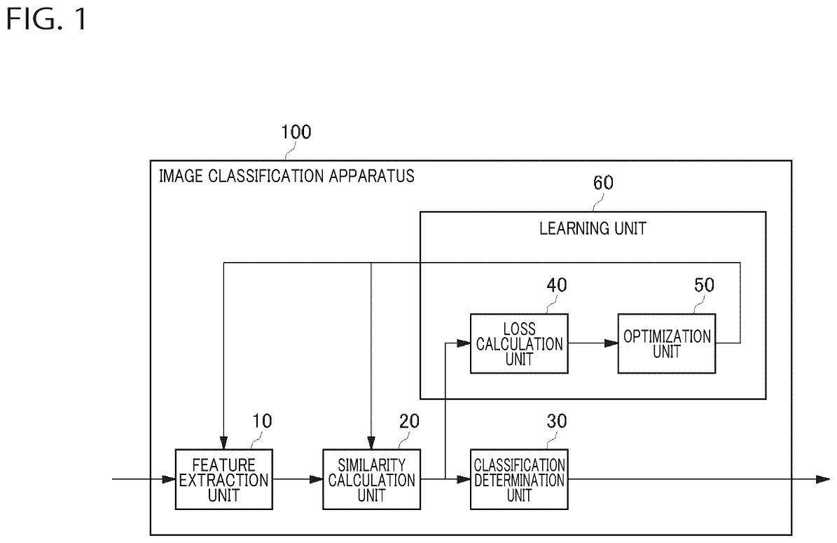

FIG. 1 is a configuration diagram of an image classification apparatus 100 according to the embodiment. The image classification apparatus 100 includes a feature extraction unit 10, a similarity calculation unit 20, a classification determination unit 30, and a learning unit 60.

At the time of learning, the image classification apparatus 100 trains the feature extraction unit 10 and the similarity calculation unit 20 in the learning unit 60 by using a training image dataset, and obtains the feature extraction unit 10 and the similarity calculation unit 20 that have been trained.

When the feature extraction unit 10 and the similarity calculation unit 20 that have been trained are obtained, the image classification apparatus 100 can classify images. At the time of classification, the image classification apparatus 100 outputs, when an image is input, a class of the input image as a classification result. At the time of classification, the learning unit 60 may not be available.

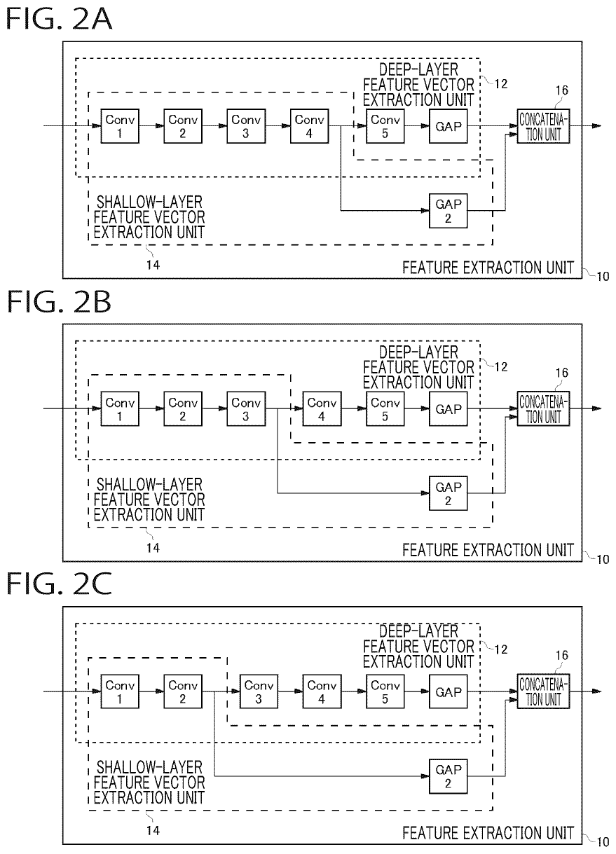

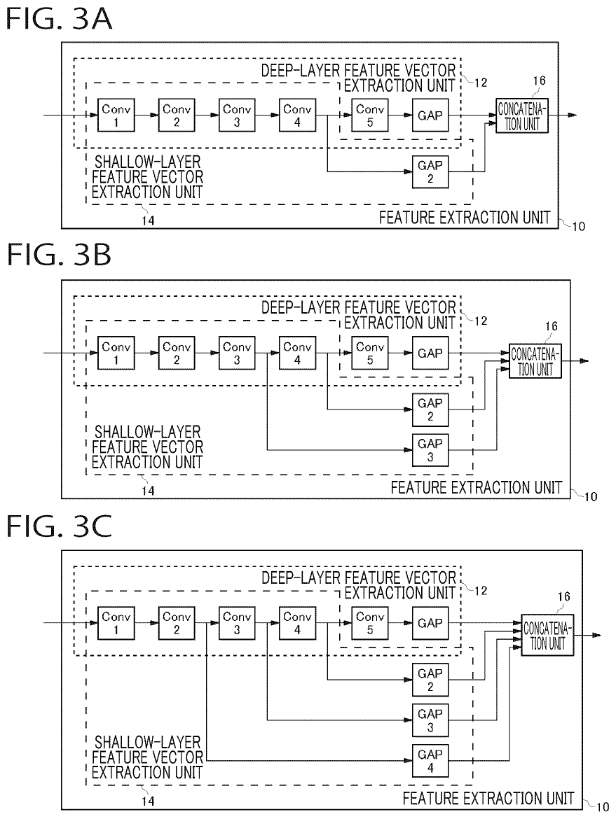

As described in detail with reference to FIGS. 2A-2C, 3A-3C, the feature extraction unit 10 includes a deep-layer feature vector extraction unit 12, a shallow-layer feature vector extraction unit 14, and a concatenation unit 16.

The deep-layer feature vector extraction unit 12 extracts a low-resolution deep-layer feature vector of the input image. The shallow-layer feature vector extraction unit 14 extracts a high-resolution shallow-layer feature vector of the input image. The concatenation unit 16 concatenates the deep-layer feature vector and the shallow-layer feature vector and outputs a concatenated feature vector.

The similarity calculation unit 20 retains the weight matrix of respective classes and calculates similarities from the concatenated feature vector and the weight matrix of respective classes.

The classification determination unit 30 determines a classification of the input image based on the similarities.

The learning unit 60 includes a loss calculation unit 40 and an optimization unit 50. The loss calculation unit 40 calculates a loss from the maximum similarity and the correct label of the input image. The optimization unit 50 trains the weight of the feature extraction unit 10 and the weight of the similarity calculation unit 20 based on the loss.

FIGS. 2A-2C are configuration diagrams of the feature extraction unit 10. In this case, a model based on ResNet-18 is used as the feature extraction unit 10. The feature extraction unit 10 may be a deep learning network other than ResNet-18 such as VGG16, ResNet-34, Vision Transformer, etc. that have a large number of weight parameters.

The feature extraction unit 10 of ResNet-18 includes CONV1 to CONV5, which are convolutional layers, and a GAP (Global Average Pooling) layer. CONV2 through CONV5 each includes four convolutional layers. GAP converts the feature map output from the convolutional layers into a feature vector.

The feature extraction unit 10 includes CONV1 to CONV5, GAP, GAP2, and the concatenation unit 16.

In each of FIG. 2A-FIG. 2C, a 7×7 512-channel feature map is input to GAP from CONV5, which is the last layer of the convolutional layer, and a deep-layer feature vector of 512 dimensions is output. It is noted here that CONV1 to CONV5 and GAP are the deep-layer feature vector extraction unit 12 that extracts a deep-layer feature vector.

In the case of FIG. 2A, a 14×14 256-channel feature map is input from CONV4 to GAP2, and a shallow-layer feature vector of 256 dimensions is output. It is noted here that CONV1 to CONV4 and GAP2 are the shallow-layer feature vector extraction unit 14 that extracts a shallow-layer feature vector.

In the case of FIG. 2A, the deep-layer feature vector extraction unit 12 and the shallow-layer feature vector extraction unit 14 share CONV1 to CONV4.

In the case of FIG. 2B, a 28×28 128-channel feature map is input from CONV3 to GAP2, and a shallow-layer feature vector of 128 dimensions is output. It is noted here that CONV1 to CONV3 and GAP2 are the shallow-layer feature vector extraction unit 14 that extracts a shallow-layer feature vector.

In the case of FIG. 2B, the deep-layer feature vector extraction unit 12 and the shallow-layer feature vector extraction unit 14 share CONV1 to CONV3.

In the case of FIG. 2C, a 56×56 64-channel feature map is input from CONV2 to GAP2, and a shallow-layer feature vector of 64 dimensions is output. It is noted here that CONV1 to CONV2 and GAP2 are the shallow-layer feature vector extraction unit 14 that extracts a shallow-layer feature vector.

In the case of FIG. 2C, the deep-layer feature vector extraction unit 12 and the shallow-layer feature vector extraction unit 14 share CONV1 to CONV2.

The deep-layer feature vector output by the deep-layer feature vector extraction unit 12 is input to the concatenation unit 16, and the shallow-layer feature vector output by the shallow-layer feature vector extraction unit 14 is input to the concatenation unit 16.

The concatenation unit 16 concatenates the deep-layer feature vector of m dimensions and the shallow-layer feature vector of n dimensions to generate a concatenated feature vector of (m+n) dimensions. In the case of FIG. 2A, m=512 and n=256 so that a concatenated feature vector of 768 dimensions is generated. In the case of FIG. 2B, m=512 and n=128 so that a concatenated feature vector of 640 dimensions is generated. In the case of FIG. 2C, m=512 and n=64 so that a concatenated feature vector of 576 dimensions is generated.

By concatenating the deep-layer feature vector and the shallow-layer feature vector, the number of dimensions of the feature vector increases, and capability to represent the feature is improved. In more detail, the deep-layer feature vector is based on a 7×7 feature map. On the other hand, the shallow-layer feature vector is based on a 14×14 feature map in the case of, for example, FIG. 2A. It is noted here that one item of data for a 7×7 feature map convolves a wider area of the input image than one item of data for a 14×14 feature map and so is considered to include summary information on an image locality. On the other hand, one item of data for a 14×14 feature map convolves a narrower area of the input image than one item of data for a 7×7 feature map and so is considered to include detailed information on an image locality. By using a plurality of feature vectors having different convoluted ranges, the capability to represent the feature is improved.

The deep-layer feature vector extraction unit 12 extracts a low-resolution feature vector, and the shallow-layer feature vector extraction unit 14 extracts a high-resolution feature vector, respectively. This is based on the fact that the deep-layer feature vector extraction unit 12 utilizes a feature map with a lower resolution than the shallow-layer feature vector extraction unit 14, and the shallow-layer feature vector extraction unit 14 utilizes a feature map with a higher resolution than the deep-layer feature vector extraction unit 12.

Further, the deep-layer feature vector extraction unit 12 extracts a feature vector of a deep layer close to the output of the deep neural network. The shallow-layer feature vector extraction unit 14 extracts a feature vector of a shallow layer close to the input of the deep neural network. For this reason, the feature vectors output by the deep-layer feature vector extraction unit 12 and the shallow-layer feature vector extraction unit 14 are referred to as a deep-layer feature vector and a shallow-layer feature vector, respectively.

It is preferred that the larger the number of training images at the time of learning, the smaller the number of convolutional layers that the shallow-layer feature vector extraction unit 14 shares with the deep-layer feature vector extraction unit 12. For example, the relationship between the number of training images and the intermediate layer used by the shallow-layer feature vector extraction unit 14 may be as follows.

When the number of training images per class is less than 100, the shallow-layer feature vector extraction unit 14 does not use an intermediate layer. In this case, since the shallow-layer feature vector extraction unit 14 is substantially the same as the deep-layer feature vector extraction unit 12, the feature extraction unit 10 does not acquire the shallow-layer feature vector, and only acquires the deep-layer feature vector. The concatenation unit 16 directly uses the deep-layer feature vector as the concatenated feature vector.

When the number of training images per class is 100 or more and less than 200, the shallow-layer feature vector extraction unit 14 uses CONV4 as the intermediate layer. This is the case of FIG. 2A, and the deep-layer feature vector extraction unit 12 outputs the shallow-layer feature vector based on a 14×14 feature map output from CONV4.

When the number of training images per class is 200 or more and less than 500, the shallow-layer feature vector extraction unit 14 uses CONV3 as the intermediate layer. This is the case of FIG. 2B, and the deep-layer feature vector extraction unit 12 outputs the shallow-layer feature vector based on a 28×28 feature map output from CONV 3.

When the number of training images per class is 500 or more, the shallow-layer feature vector extraction unit 14 uses CONV2 as the intermediate layer. This is the case of FIG. 2C, and the deep-layer feature vector extraction unit 12 outputs the shallow-layer feature vector based on a 56×56 feature map output from CONV2.

Thus, the larger the number of training images, the shallower the intermediate layer used to determine the shallow-layer feature vector. In other words, the shallow-layer feature vector extraction unit 14 shares fewer convolutional layers with the deep-layer feature vector extraction unit 12 as the number of training images increases.

On the other hand, the smaller the number of training images, the deeper the intermediate layer used to determine the shallow-layer feature vector. In other words, the shallow-layer feature vector extraction unit 14 shares more convolutional layers with the deep-layer feature vector extraction unit 12 as the number of training images decreases.

The farther the intermediate layer is away from the last layer, the more different the feature output from the intermediate layer is from that of the last layer. When optimization is performed by backpropagation, layers close to the last layer are more readily optimized than the other layers. When using a layer away from the last layer, therefore, the larger the number of training images, the more preferable. By using a shallower intermediate layer as the number of training images increases, it is possible to use an intermediate layer that is far from the last layer, is reliable, and has a characteristic different from the last layer.

FIGS. 3A-3C show further exemplary configuration diagrams of the feature extraction unit 10. The shallow-layer feature vector extraction unit 14 extracts a plurality of shallow-layer feature vectors, and two or more feature vectors are input to the concatenation unit 16. The configuration of FIG. 3A is substantially the same as the configuration of FIG. 2A, but for convenience of explanation, it will be discussed here as well.

In the case of FIG. 3A, the feature extraction unit 10 includes CONV1 to CONV5, GAP, GAP2, and the concatenation unit 16, and in the case of FIG. 3B, it further includes GAP3, and in the case of FIG. 3C, it further includes GAP4.

In any of cases of FIG. 3A-FIG. 3C, a 7×7 512-channel feature map is input to GAP from CONV5, which is the last layer of the convolutional layer, and a deep-layer feature vector of 512 dimensions is output. It is noted here that CONV1 to CONV5 and GAP are the deep-layer feature vector extraction unit 12 that extracts a deep-layer feature vector.

In the case of FIG. 3A, a 14×14 256-channel feature map is input from CONV4 to GAP2, and a first shallow-layer feature vector of 256 dimensions is output. It is noted here that CONV1 to CONV4 and GAP2 are the shallow-layer feature vector extraction unit 14 that extracts a shallow-layer feature vector.

In the case of FIG. 3B, a 14×14 256-channel feature map is input from CONV4 to GAP2, and a first shallow-layer feature vector of 256 dimensions is output. A 28×28 128-channel feature map of is input from CONV3 to GAP3, and a second shallow-layer feature vector of 128 dimensions is output. It is noted here that CONV1 to CONV4, GAP2, and GAP3 are the shallow-layer feature vector extraction unit 14 that extracts a shallow-layer feature vector.

In the case of FIG. 3C, a 14×14 256-channel feature map is input from CONV4 is input to GAP2, and a first shallow-layer feature vector of 256 dimensions is output. A 28×28 128-channel feature map is input from CONV3 to GAP3, and a second shallow-layer feature vector of 128 dimensions is output. A 56×56 64-channel feature map is input from CONV2 to GAP4, and a third shallow-layer feature vector of 64 dimensions is output. It is noted here that CONV1 to CONV4 and GAP2 to GAP4 are the shallow-layer feature vector extraction unit 14 that extracts a shallow-layer feature vector.

The deep-layer feature vector output by the deep-layer feature vector extraction unit 12 is input to the concatenation unit 16, and the plurality of shallow-layer feature vectors output by the shallow-layer feature vector extraction unit 14 are input to the concatenation unit 16.

The concatenation unit 16 concatenates the deep-layer feature vector and the plurality of shallow-layer feature vectors to generate a concatenated feature vector. In the case of FIG. 3A, a concatenated feature vector of 768 dimensions is generated by concatenating the deep-layer feature vector of 512 dimensions and the first shallow-layer feature vector of 256 dimensions. In the case of FIG. 3B, a concatenated feature vector of 896 dimensions is generated by concatenating the deep-layer feature vector of 512 dimensions, the first shallow-layer feature vector of 256 dimensions, and the second shallow-layer feature vector of 128 dimensions. In the case of FIG. 3C, a concatenated feature vector of 960 dimensions is generated by concatenating the deep-layer feature vector of 512 dimensions, the first shallow-layer feature vector of 256 dimensions, the second shallow-layer feature vector of 128 dimensions, and the third shallow-layer feature vector of 64 dimensions.

It is preferred that, as the number of training images at the time of learning increases, the shallow-layer feature vector extraction unit 14 extracts a plurality of shallow-layer feature vectors from the feature maps output by a larger number of convolutional layers. For example, the relationship between the number of training images and the intermediate layer used by the shallow-layer feature vector extraction unit 14 may be as follows.

When the number of training images per class is less than 100, the shallow-layer feature vector extraction unit 14 does not use an intermediate layer. In this case, since the shallow-layer feature vector extraction unit 14 is substantially the same as the deep-layer feature vector extraction unit 12, the feature extraction unit 10 does not acquire the shallow-layer feature vector, and only acquires the deep-layer feature vector. The concatenation unit 16 directly uses the deep-layer feature vector as the concatenated feature vector.

When the number of training images per class is 100 or more and less than 200, the shallow-layer feature vector extraction unit 14 uses CONV4 as the intermediate layer. This is the case of FIG. 3A, and the deep-layer feature vector extraction unit 12 outputs the first shallow-layer feature vector based on a 14×14 feature map output from CONV4.

When the number of training images per class is 200 or more and less than 500, the shallow-layer feature vector extraction unit 14 uses CONV4 and CONV3 as the intermediate layer. This is the case of FIG. 3B, and the deep-layer feature vector extraction unit 12 outputs the first shallow-layer feature vector based on a 14×14 feature map output from CONV 4 and the second shallow-layer feature vector based on a 28×28 feature map output from CONV 3.

When the number of training images per class is 500 or more, the shallow-layer feature vector extraction unit 14 uses CONV4, CONV3, and CONV2 as the intermediate layer. This is the case of FIG. 3C, and the deep-layer feature vector extraction unit 12 outputs the first shallow-layer feature vector based on a 14×14 feature map output from CONV4, the second shallow-layer feature vector based on a 28×28 feature map output from CONV3, and the third shallow-layer feature vector based on a 56×56 feature map output from CONV2.

Thus, the larger the number of training images, the larger the number of intermediate layers used to to determine a plurality of shallow-layer feature vectors. Meanwhile, the smaller the number of training images, the smaller the number of intermediate layers used to determine a plurality of shallow-layer feature vectors.

The farther the intermediate layer is away from the last layer, the more different the feature output from the intermediate layer is from that of the last layer. When optimization is performed by backpropagation, layers close to the last layer are more readily optimized than the other layers. When using a layer away from the last layer, therefore, the larger the number of training images, the more preferable. By using a large number of shallow intermediate layers additionally as the number of training images increases, it is possible to use a large number of intermediate layers additionally that are far from the last layer, are reliable, and have a characteristic different from the last layer. By reducing the number of shallow intermediate layers and restricting the use of intermediate layers when the number of training images is small, learning time is reduced and computing cost required for inference is reduced.

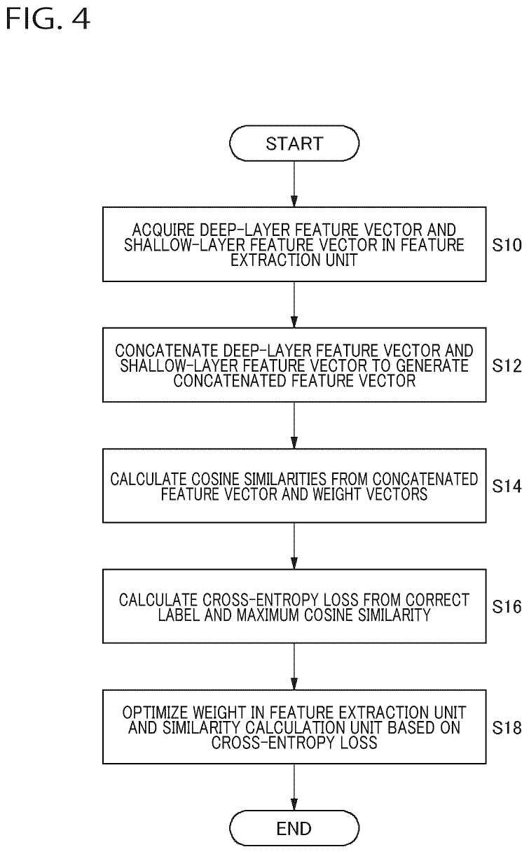

FIG. 4 is a flowchart showing the learning process performed by the image classification apparatus 100. The learning process of FIG. 4 is executed in batches. The batch size may be a general numerical value such as 512.

The training image is input to the feature extraction unit 10 in batch size units.

In the feature extraction unit 10, the deep-layer feature vector extraction unit 12 acquires a deep-layer feature vector, and the shallow-layer feature vector extraction unit 14 acquires a shallow-layer feature vector (S10).

The concatenation unit 16 concatenates the deep-layer feature vector and the shallow-layer feature vector to generate a concatenated feature vector, and supplies the concatenated feature vector to the similarity calculation unit 20 (S12).

The similarity calculation unit 20 has a weight matrix of a linear layer (fully connected layer) for calculating the cosine similarities. The weight matrix has a weight parameter of (DxNC) dimensions. D denotes the same number of dimensions as the concatenated feature vector input to the linear layer, and NC denotes the number of classes. For example, D=768, NC=100.

The concatenated feature vector input to the similarity calculation unit 20 is normalized, and the normalized concatenated feature vector is input to the linear layer of the similarity calculation unit 20. It is noted here that the weight vector of the linear layer is normalized. The similarity calculation unit 20 calculates cosine similarities of NC dimensions between the concatenated feature vector and the weight vectors of respective classes in classification (S14). By normalizing the concatenated feature vector and calculating the cosine similarities, intraclass variance can be suppressed and classification accuracy can be improved.

The loss calculation unit 40 calculates a cross-entropy loss, which is a loss defined between the maximum cosine similarity and the correct label (correct class) of the input image (S16).

The optimization unit 50 optimizes the weight parameters of the convolutional layer of the feature extraction unit 10 and the weight matrix of the similarity calculation unit 20 by backpropagation by using an optimization method such as stochastic gradient descent (SGD) and Adam in such a manner as to minimize the cross-entropy loss (S18).

As described above, the feature representation capability of the feature extraction unit 10 can be improved by training according to the cross-entropy loss, based on the concatenated feature vector having an increased number of dimensions as a result of concatenating the deep-layer feature vector and the shallow-layer feature vector.

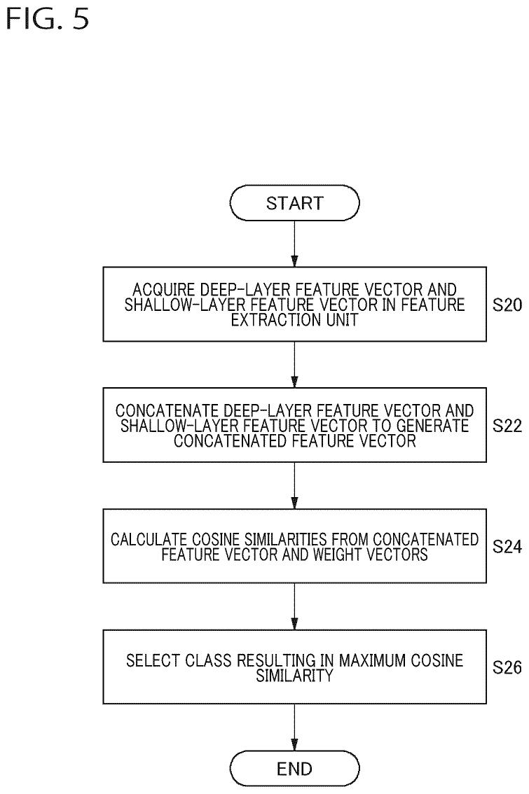

FIG. 5 is a flowchart illustrating the classification process performed by the image classification apparatus. The classification process of FIG. 5 is processed in units of one or more images.

An image subject to classification is input to the feature extraction unit 10 in units of one or more images.

In the feature extraction unit 10, the deep-layer feature vector extraction unit 12 acquires a deep-layer feature vector, and the shallow-layer feature vector extraction unit 14 acquires a shallow-layer feature vector (S20).

The concatenation unit 16 concatenates the deep-layer feature vector and the shallow-layer feature vector to generate a concatenated feature vector, and supplies the concatenated feature vector to the similarity calculation unit 20 (S22).

The concatenated feature vector input to the similarity calculation unit 20 is normalized, and the normalized concatenated feature vector is input to the linear layer of the similarity calculation unit 20. The similarity calculation unit 20 calculates cosine similarities between the concatenated feature vector and the weight vectors of respective classes in classification (S24).

The classification determination unit 30 refers to the cosine similarities and determines a class resulting in the maximum similarity (S26).

As described above, classification accuracy can be improved by classifying the image based on the concatenated feature vector having an increased number of dimensions as a result of concatenating the deep-layer feature vector and the shallow-layer feature vector.

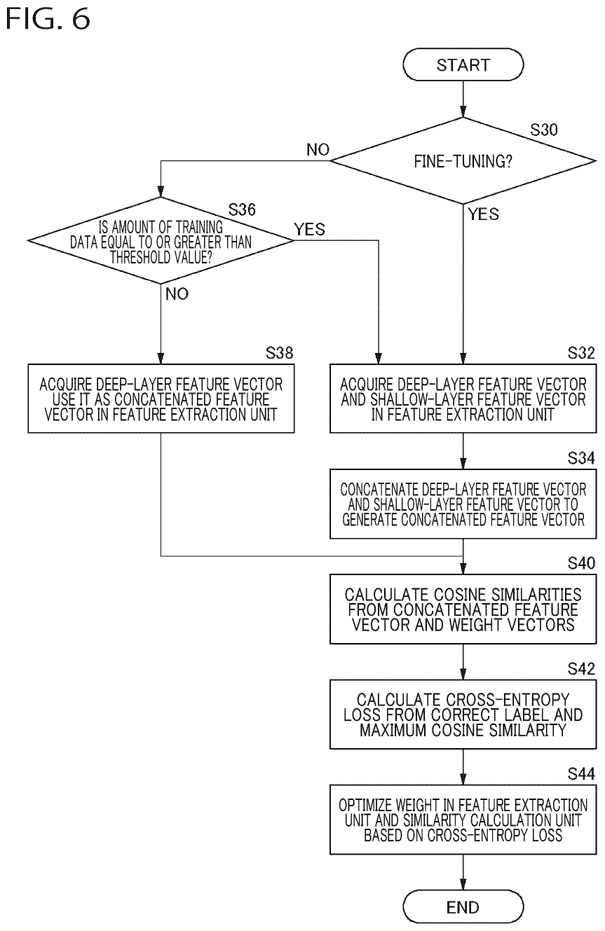

FIG. 6 is a flowchart illustrating another example of the learning processing performed by the image classification apparatus 100. The difference from the learning process of FIG. 4 is that a determination process is added to determine whether to generate a concatenated feature vector with an increased number of dimensions by concatenating the deep-layer feature vector and the shallow-layer feature vector, or to use the deep-layer feature vector directly as the concatenated feature vector.

In the case the weight parameter of the convolutional layer of the feature extraction unit 10 has already been trained and the weight parameter of the trained convolutional layer is fine-tuned (YES in S30), the deep-layer feature vector extraction unit 12 in the feature extraction unit 10 acquires a deep-layer feature vector, the shallow-layer feature vector extraction unit 14 acquires a shallow-layer feature vector (S32), and the concatenation unit 16 generates a concatenated feature vector by concatenating the deep-layer feature vector and the shallow-layer feature vector, and supplies the concatenated feature vector to similarity calculation unit 20 (S34).

In the case of normal learning that is not fine-tuning and, for example, learning in which the initial weight of the neural network is set to 0 or a random value (NO in S30), the deep-layer feature vector extraction unit 12 in the feature extraction unit 10 acquires a deep-layer feature vector, the shallow-layer feature vector extraction unit 14 acquires a shallow-layer feature vector (S32), and the concatenation unit 16 generates a concatenated feature vector by concatenating the deep-layer feature vector and the shallow-layer feature vector (S34), given that the amount of data for the training image is equal to or greater than a threshold value (YES in S36). Control the proceeds to step S40.

In the case of normal learning that is not fine-tuning (NO in S30), the deep-layer feature vector extraction unit 12 in the feature extraction unit 10 acquires a deep-layer feature vector, and the shallow-layer feature vector extraction unit 14 does not acquire a shallow-layer feature vector, and the concatenation unit 16 uses the deep-layer feature vector directly as the concatenated feature vector (S38), given that the amount of data for the training image is less than the threshold value (NO in S36). In this case, the number of dimensions of the concatenated feature vector remains the number of dimensions of the deep-layer feature vector. Control the proceeds to step S40.

The threshold value to be compared with the data amount of the training image is determined by the amount of weight parameters of the feature extraction unit 10. The larger the amount of weight parameters of the feature extraction unit 10, the greater the amount of data for the training image required for sufficient learning. In this case, the threshold value of 100 training images per class is set by way of example.

The similarity calculation unit 20 calculates cosine similarities between the concatenated feature vector and the weight vectors of respective classes in classification (S40).

The loss calculation unit 40 calculates a cross-entropy loss, which is a loss defined between the maximum cosine similarity and the correct answer label (correct answer class) of the input image (S42).

The optimization unit 50 optimizes the weight parameters of the convolutional layer of the feature extraction unit 10 and the weight matrix of the similarity calculation unit 20 by backpropagation in such a manner as to minimize cross-entropy loss (S44).

In the case of fine-tuning, or in the case the amount of data for the training image is equal to or greater than the threshold value, the deep-layer feature vector and the shallow-layer feature vector are sufficiently learned, and the capability of the feature extraction unit to represent the feature can be improved by training according to the cross-entropy loss, based on the concatenated feature vector having an increased number of dimensions as a result of concatenating the deep-layer feature vector and the shallow-layer feature vector.

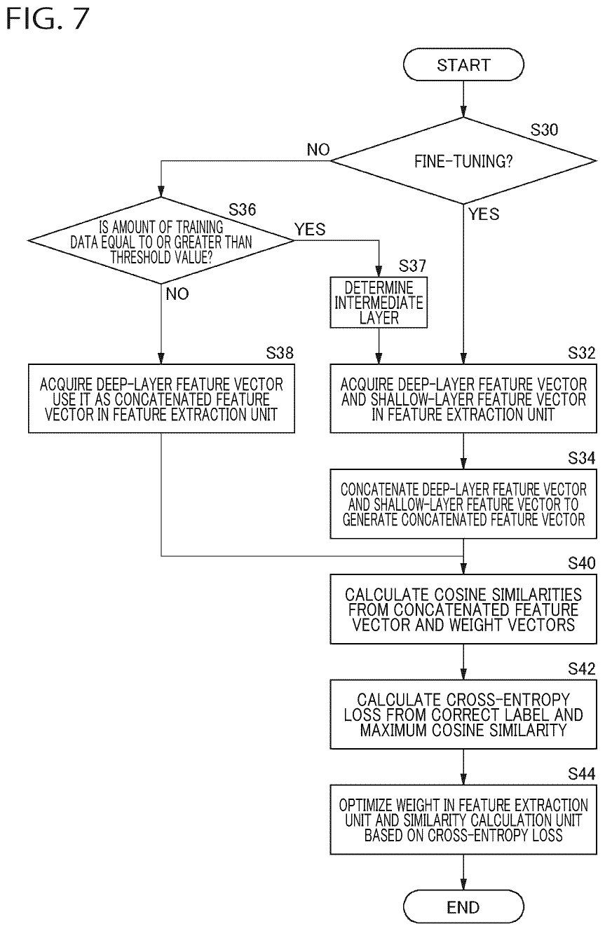

FIG. 7 is a flowchart illustrating still another example of the learning process performed by the image classification apparatus 100. The difference from the learning process of FIG. 6 is that a process of determining the intermediate layer used by the shallow-layer feature vector extraction unit 14 based on the amount of data for the training image is added. Since the other aspects are the same as those of the learning process of FIG. 6, the same step is denoted by the same reference numeral, a description thereof is omitted, and only the difference is described.

In the case of normal learning that is not fine-tuning (NO in S30), the intermediate layer to be used by the shallow-layer feature vector extraction unit 14 is determined based on the amount of data for the training image (S37), given that the amount of data for the training image is equal to or greater than the threshold value (YES in S36).

Specifically, as described with reference to FIG. 2A-FIG. 2C, the larger the number of training images, the shallower the intermediate layer used to determine the shallow-layer feature vector, and the smaller the number of training images, the deeper the intermediate layer used to determine the shallow-layer feature vector.

Alternatively, as described with reference to FIGS. 3A-3C, the larger the number of training images, the larger the number of intermediate layers used to determine a plurality of shallow-layer feature vectors, and the smaller the number of training images, the smaller the number of intermediate layers used to determine a plurality of shallow-layer feature vectors.

The above-described various processes in the image classification apparatus 100 can of course be implemented by hardware-based apparatuses such as a CPU and a memory and can also be implemented by firmware stored in a ROM (read-only memory), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

Given above is a description of the present disclosure based on the embodiment. The embodiment is intended to be illustrative only and it will be understood by those skilled in the art that various modifications to combinations of constituting elements and processes are possible and that such modifications are also within the scope of the present disclosure.

What is claimed is:

1. An image classification apparatus comprising:
a deep-layer feature vector extraction unit that extracts a low-resolution deep-layer feature vector of an input image;
a shallow-layer feature vector extraction unit that extracts a high-resolution shallow-layer feature vector of the input image;
a concatenation unit that concatenates the deep-layer feature vector and the shallow-layer feature vector and outputs a concatenated feature vector;
a similarity calculation unit that retains a weight matrix of respective classes and calculates similarities from the concatenated feature vector and the weight matrix of respective classes; and
a classification determination unit that determines a classification of the input image based on the similarities.

2. The image classification apparatus according to claim 1, wherein
the shallow-layer feature vector extraction unit shares at least one convolutional layer with the deep-layer feature vector extraction unit.

3. The image classification apparatus according to claim 2, wherein
the larger the number of training images at the time of learning, the smaller the number of convolutional layers that the shallow-layer feature vector extraction unit shares with the deep-layer feature vector extraction unit.

4. The image classification apparatus according to claim 2, wherein
as the number of training images at the time of learning increases, the shallow-layer feature vector extraction unit extracts a plurality of shallow-layer feature vectors from feature maps output by a larger number of convolutional layers, and
the concatenation unit that concatenates the deep-layer feature vector and the plurality of shallow-layer feature vectors and outputs a concatenated feature vector.

5. An image classification method comprising:
extracting a low-resolution deep-layer feature vector of an input image;
extracting a high-resolution shallow-layer feature vector of the input image;
concatenating the deep-layer feature vector and the shallow-layer feature vector and outputting a concatenated feature vector;
retaining a weight matrix of respective classes and calculating similarities from the concatenated feature vector and the weight matrix of respective classes; and
determining a classification of the input image based on the similarities.

6. A non-transitory computer-readable medium having an image classification program comprising computer-implemented modules including:
a module that extracts a low-resolution deep-layer feature vector of an input image;
a module that extracts a high-resolution shallow-layer feature vector of the input image;
a module that concatenates the deep-layer feature vector and the shallow-layer feature vector and outputs a concatenated feature vector;
a module that retains a weight matrix of respective classes and calculates similarities from the concatenated feature vector and the weight matrix of respective classes; and
a module that determines a classification of the input image based on the similarities.
